(19) United States
(12) Patent Application Publication
(10) Pub. No.: US 2013/0332249 A1
(43) Pub. Date: Dec. 12, 2013

(54) OPTIMAL SUPPLEMENTARY AWARD ALLOCATION

(71) Applicant: INTERNATIONAL BUSINESS MACHINES CORPORATION, Armonk, NY (US)

(72) Inventors: Winnie Wing-Yee CHENG, Tarrytown, NY (US); Anshul Sheopuri, White Plains, NY (US)

(73) Assignee: International Business Machines Corporation, Armonk, NY (US)

(21) Appl. No.: 13/690,242

(22) Filed: Nov. 30, 2012

Related U.S. Application Data
(60) Provisional application No. 61/657,992, filed on Jun. 11, 2012.

(51) Int. Cl. G06Q 30/02

(52) U.S. Cl. CPC G06Q 30/0211
USPC 705/14.13

(57) ABSTRACT

A method of allocating a new incentive to a portion of a population includes identifying a plurality of group features of the population based on retention data clustering members of the population into a plurality of groups having similar risk profiles based on the plurality of group features and a plurality of categorical factors, dividing each of the plurality of groups into an experimental group and a control group respectively corresponding to members of the population that have received a previous incentive and that have not received the previous incentive, computing an effectiveness score of the previous incentive for each group based on a comparison of the corresponding experimental group and the corresponding control group, and generating a set of potential target groups for the new incentive based on the effectiveness scores.

### CROSS-REFERENCE TO RELATED PATENT APPLICATION

This application claims priority to and the benefit of Provisional Application Ser. No. 61/657,992, filed on Jun. 11, 2012, the disclosure of which is herein incorporated by reference in its entirety.

### BACKGROUND

1. Technical Field

The present invention relates to optimal supplementary award allocation, and more particularly, to a system and method of optimal supplementary award allocation.

2. Discussion of Related Art

In economic relationships, one party typically exchanges funds with another party in return for goods or services. For example, a merchant may provide goods to customers in return for funds, or a service provider, such as a wireless telephone service provider, may provide a service, such as cellular telephone service in return for funds.

Parties in such relationships may want to be sure that goods and/or services are fairly priced. For example, merchants and/or service providers may want to ensure that their customers will be happy with the price offered, and will not take their business elsewhere in response to finding a better price for the same or similar goods and/or services.

### BRIEF SUMMARY

According to an exemplary embodiment of the present invention, in an economic relationship between a first party and a population of second parties in connection with provision of at least one of goods and services for a fee, a method includes identifying a plurality of rule-based group features of the population, based on similar retention behavior, clustering the population into rule-based groups with similar risk profiles based on the rule-based group features and categorical factors, and subdividing the rule-based groups into experimental and control groups. The experimental groups are characterized in that they have received a previous inducement to continue the economic relationship, and the control groups are characterized in that they have not received the previous inducement to continue the economic relationship. The method may further include evaluating effectiveness of the previous inducement to continue the economic relationship based on a comparison of the experimental and control groups, based on the evaluating step, generating a set of potential target groups, filtering the potential target groups based on incentive program rules, optimizing at least one cost and at least one benefit of retention on the potential target groups, and, based on the optimization, selecting an optimal set of the subgroups to receive a new inducement to continue the economic relationship.

According to an exemplary embodiment of the present invention, a method of allocating a new incentive to a portion of a population includes receiving retention data, identifying a plurality of group features of the population based on the retention data, clustering members of the population into a plurality of groups having similar risk profiles, based on the plurality of group features and a plurality of categorical factors, dividing each of the plurality of groups into an experimental group and a control group, wherein the experimental groups correspond to members of the population that have received a previous incentive, and the control groups correspond to members of the population that have not received the previous incentive, computing an effectiveness score of the previous incentive for each group based on a comparison of a corresponding experimental group and a corresponding control group, and generating a set of potential target groups for the new incentive based on the effectiveness scores.

According to an exemplary embodiment of the present invention, a method of allocating a new incentive to a portion of a population includes receiving retention data, clustering members of the population into a plurality of groups based on the retention data, dividing each of the plurality of groups into an experimental group and a control group, wherein the experimental groups correspond to members of the population that have received a previous incentive, and the control groups correspond to members of the population that have not received the previous incentive, computing a first retention rate of each of the experimental groups, computing a second retention rate of each of the control groups, computing an effectiveness score of the previous incentive for each group based on the first retention rate, the second retention rate, and a predefined threshold, and generating a set of potential target groups for the new incentive based on the effectiveness scores.

According to an exemplary embodiment of the present invention, an incentive allocation system includes an identification module and a group construction module. The identification module is configured to identify a plurality of group features of a population based on retention data. The group construction module is configured to cluster members of the population into a plurality of groups having similar risk profiles based on the plurality of group features and a plurality of categorical factors, divide each of the plurality of groups into an experimental group and a control group, wherein the experimental groups correspond to members of the population that have received a previous incentive, and the control groups correspond to members of the population that have not received the previous incentive, compute an effectiveness score of the previous incentive for each group based on a comparison of a corresponding experimental group and a corresponding control group, and generate a set of potential target groups for the new incentive based on the effectiveness scores.

### BRIEF DESCRIPTION OF THE DRAWINGS

The above and other features of the present invention will become more apparent by describing in detail exemplary embodiments thereof with reference to the accompanying drawings, in which:

FIG. 1 shows a combined flow chart and software architecture diagram, according to an exemplary embodiment of the present invention.

FIG. 2 shows an exemplary three-dimensional response curve, according to an exemplary embodiment of the present invention.

FIG. 3 shows an exemplary computer system for performing optimal supplementary award allocation, according to an exemplary embodiment of the present invention.

FIG. 4 shows a system for performing optimal supplementary award allocation, according to an exemplary embodiment of the present invention.

FIG. 5 is a flowchart showing a method of performing optimal supplementary award allocation, according to an exemplary embodiment of the present invention.

FIG. 6 shows a population clustered into a plurality of groups, and the plurality of groups divided into experimental and control groups, according to an exemplary embodiment of the present invention.

### DETAILED DESCRIPTION OF THE EXEMPLARY EMBODIMENTS

Exemplary embodiments of the present invention will be described more fully hereinafter with reference to the accompanying drawings. Like reference numerals may refer to like elements throughout the accompanying drawings.

Exemplary embodiments of the present invention address the issue of optimizing investment on supplementary incentive schemes given a primary incentive mechanism for customer retention. A primary incentive may be, for example, a discounted subscription rate. The duration of a primary incentive scheme is often longer than the duration of a supplementary incentive scheme.

In the following description, the terms award and incentive are synonymous and can be used interchangeably.

A supplementary incentive scheme may include, for example, a gift certificate given to a soon-to-expire subscriber, which may increase the likelihood of renewal, or the ability to access special deals from preferred retailers (e.g., American Express®).

In general, distributing awards to all customers in a population may increase the overall retention rate, however, may be very expensive. In contrast, failure to give out enough awards may result in preventable loss of customers. Further, different sub-populations respond differently to incentives. The primary incentive scheme is typically already invested in one or more selected subpopulations and may impact the effectiveness of supplementary scheme(s). Exemplary embodiments of the present invention allow for the determination of the optimal investment in supplementary awards, and/or the determination of which customer sub-population(s) such rewards should be focused on.

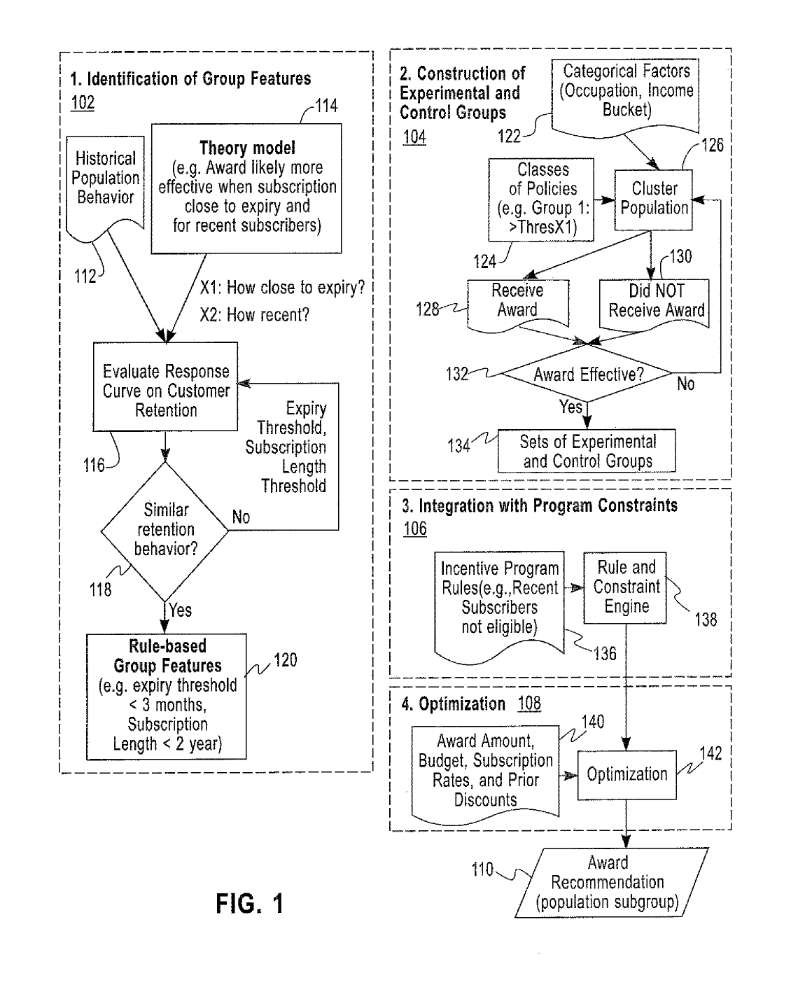

FIG. 1 shows a combined flow chart and software architecture diagram, according to an exemplary embodiment of the invention.

An overview of FIG. 1 shows that an exemplary embodiment of the present invention may include the identification of group features (block 102), the construction of experimental and control groups (block 104), integration with program constraints (block 106), and optimization (block 108). During the identification of group features (block 102), factors that characterize a subpopulation may be evaluated based on theoretical models, primary incentive scheme factors, and/or domain expertise. During the construction of experimental and control groups (block 104), groups with similar risk profiles may be identified, groups may be divided into experimental groups (e.g., groups that received an award) and control groups (e.g., groups that did not receive an award), and the effectiveness of allocating the award relative to retention may be assessed. This process may be performed iteratively to arrive at a set of potential target subpopulations and the assessed effectiveness. During the integration with program constraints (block 106), incentive program constraints may be combined with target group features. During optimization (block 108), a cost-benefit analysis based on retention may be performed, and a recommended set of target groups for optimal return on investment may be generated. FIG. 1 is described in further detail herein.

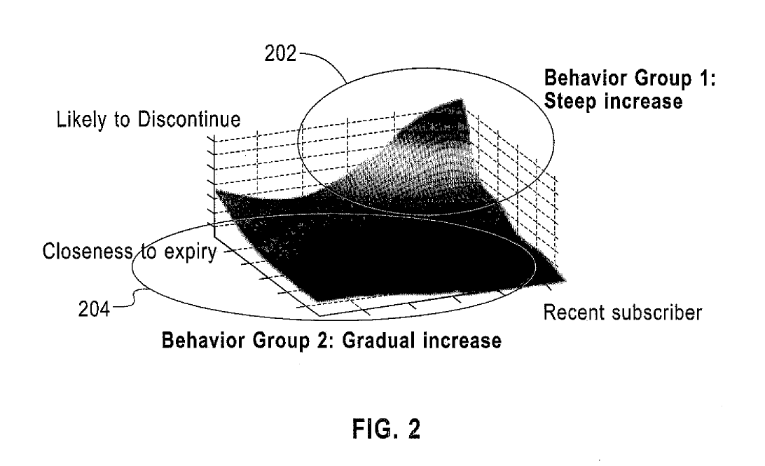

Referring to FIG. 1, in an economic relationship between a first party (e.g., a provider of goods and/or services) and a population (e.g., customers), in which the first party offers at least one of goods and/or services for a fee to members of the population, a plurality of rule-based group features of the population may be identified at block 102 based on similar retention behavior. At block 102, data including variables potentially suitable for grouping the population may include historical population behavior 112, a theory model 114, and/or a domain expert. Primary incentive schemes may be focused on a subgroup (e.g., historical population behavior 112), and theoretical studies of the theory model 114 may suggest some parameters that may influence customer retention. These factors are used as a first-pass segmentation of population. For example, with regard to time to subscription expiry, customers with subscriptions close to expiry may be more likely to leave (e.g., variable X1 in FIG. 1). With regard to subscription length, customers who have recently started subscribing may also be more likely to leave (e.g., variable X2 in FIG. 1). At block 116, an evaluation may be performed. The evaluation may include, for example, evaluating a customer retention curve relating to the subpopulations based on the variables received (e.g., historical population behavior 112 and theoretical studies from the theory model 114). For example, subscription expiry may be plotted with the rate of customer retention as a function of expiry, as shown in FIG. 2. In exemplary embodiments, a mathematical fit or another relationship may be utilized rather than a physical plot, and/or a correlation analysis may be utilized. At block 118, features segmenting the population into groups with similar retention behavior may be identified. Features and rule set(s) may be developed to distinguish groups by response behavior, as shown at block 120. For example, a sub-group of interest may have a time to subscription expiry less than 9 months, and/or a subscription length less than 5 years. In another example, a sub-group of interest may have an expiry threshold of less than 3 months and/or a subscription length of less than 2 years.

Theory model 114 may reflect, for example, the theoretical observation or prediction that an incentive or award is likely to be more effective when offered to a member of the population whose subscription is close to expiry and/or who has only recently subscribed. For example, an individual may be most likely to leave right after he or she signs up, or right before his or her subscription runs out. Alternatively, for two people with a one year subscription, the person for whom the subscription is a first subscription is more likely to leave than another person who has multiple consecutive one year subscriptions. Thus, parameters X1 and X2, which respectively correspond to how close the individual's subscription is to expiry and how recent the individual became a new subscriber, may be deemed to be pertinent. These parameters may be utilized to construct groups and subgroups. The parameters utilized to construct groups and subgroups are not limited to X1 and X2.

FIG. 2 shows an exemplary three-dimensional response curve, according to an exemplary embodiment of the present invention. The vertical axis corresponds to the likelihood that a subscriber will discontinue service, and the other axes respectively correspond to how close to expiry the subscriber is, and how recently the subscriber has subscribed. As shown in FIG. 2, those who are both close to expiry and are recent subscribers have a high likelihood of discontinuing service, and faun a first behavior group 202. In contrast, those who are close to expiry but are not recent subscribers, those who are not close to expiry but are recent subscribers, and those who are neither close to expiry nor recent subscribers have a low likelihood of discontinuing service, and form a second behavior group 204.

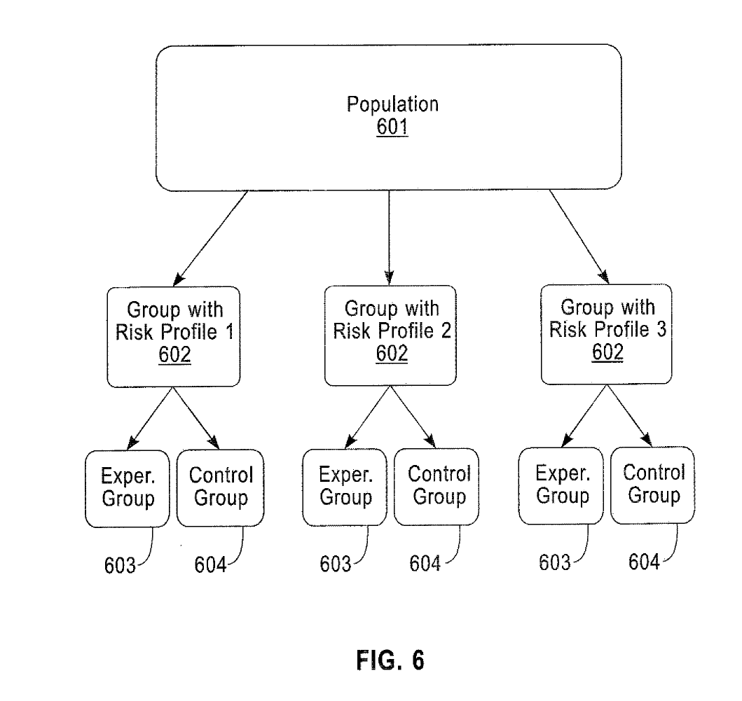

At block 104 of FIG. 1, experimental and control groups are constructed, and the effectiveness of distributing incentives is assessed. Among the segmented population, subgroups with similar risk profiles may be identified. That is, the population may be clustered into rule-based groups having similar risk profiles based on the rule-based group features obtained in block 102, as well as additional categorical factors 122. For example, as shown in FIG. 6, a population 601 is first clustered into a plurality of groups having similar risk profiles 602. Each of these groups 602 is then divided into experimental groups 603 and control groups 604. Additional categorical factors may include, for example, the occupation and income bracket of the customers. The categorical factors may be obtained from, for example, a domain expert, a theoretical model, and/or based on historical behavior. At block 126, the population may be clustered based on risk factors (e.g., categorical factors including occupation or income bracket, as shown at block 122). At block 124, a group policy may be, for example, the condition:

Occupation=“Engineer” AND Time to Expiry <9 months.

Such a policy can also be taken into account during clustering at block 126.

Within the subgroup, a controlled experiment may be established. That is, the subgroup may be divided into a plurality of groups. For example, the subgroup may be divided into an experimental group that receives an incentive (block 128) (e.g., a group of the population that has received a previous inducement to continue the economic relationship), and a control group that does not receive an incentive (block 130) (e.g., a group of the population that has not received the previous inducement to continue the economic relationship). The previous inducement may include a previous supplemental award. The previous inducement may be, for example, a prior supplemental award or a primary award. The retention rate may then be computed for each group. The effectiveness of distributing the award may be determined at block 132 based on a comparison of the experimental and control groups. For example, if the difference between the average retention rates of the experimental group and the control group is greater than a predefined threshold, the group may be tagged as a candidate award target group (block 134). If the difference between the average retention rates is not greater than the predefined threshold, the population may be clustered again based on different factors at block 126. As a result, a set of potential target groups and corresponding retention spreads and subgroup population sizes may be generated and output. For example, the population may be broken up in different ways until the groups having the highest difference between recipients of the incentive and non-recipients are obtained. For example, consider the following exemplary groups:

### Group 1

Group characteristics: Occupation “Engineer” AND Time to Subscription Expiry <9 months
Retention Spread: 90% (receive), 50% (did not receive)
Group size: 500 customers

### Group 2

Group characteristics: Occupation “Consultants” AND Subscription Length <5 years
Retention Spread: 85% (receive), 60% (did not receive)
Group size: 200 customers
   . . . .

### Group N

Referring to block 106 of FIG. 1, integration with program rule constraints may be performed. For example, at block 138, the potential target groups may be filtered based on incentive program rules 136. Filtering is performed by the rule and constraint engine 138 since the award organization running the award campaign may have established regulations on permissible target group selection criteria. For example, program rule constraints may dictate that an award cannot be given to recent subscribers (e.g., subscribers of less than one year) or subscribers under the age of 18. The rule and constraint engine 138 removes ineligible groups if selected. That is, at block 106, all of the target group selection factors in the candidate set may be processed relative to the rule database 136 using engine 138, and any factors that interfere with regulations may be removed. The target groups may then be ranked based on their retention spread. For example:

### Rank #1: Group 1, Spread=40%

GROUP (Occupation “Engineer” AND Time to Subscription Expiry <9 months)
Adjusted population size: 375 customers

### Rank #2: Group 2, Spread=15%

GROUP (Occupation “Consultants” AND Subscription Length <5 years)
Adjusted population size: 125 customers
. . . .

### Rank N

Referring to block 108 of FIG. 1, optimization is performed. For example, at block 142, at least one cost and at least one benefit of retention on the potential target groups may be optimized. During optimization, for a given investment size and award value, the set of targeted groups with optimal return based on retention costs and benefits may be determined. For example, at block 142, optimization may be performed based on factors such as award amount, available budget for awards, subscription rates, prior discount, and/or other suitable factors 140. For example, if a subgroup already has a 20-40% discount, optimization may be implemented in a different manner so as to not give the subgroup as much of a supplementary benefit (e.g., the incentive already received by the subgroup is taken into account). According to exemplary embodiments, the amount of supplemental awards members of the population may receive can be minimized or decreased if they are already receiving a substantially discounted subscription. In some cases, given a particular budget (e.g., a total incentive campaign budget of $3 million), a determination may be made regarding how many total customers to target, which customers to target, and how much of the total budget is to be given to each customer. In an exemplary embodiment, convex optimization may be employed. Further, in some cases, a determination may be made as to whether to give a customer an incentive based on a cut-off threshold corresponding to how many incentives the customer has received in the past.

For example, suppose a customer is already in a group of interest and the number of awards people receive versus retention rate has been plotted. A point is reached where, even if individuals receive further awards, the retention rate does not change significantly (e.g., perhaps after ten awards, giving further awards does little or no good). At block 108, the optimal return on investment may be computed, and a set of target groups may be recommended by identifying retention cost differences in the targeted groups. For example, it may be less costly to replace a group that has received discounted subscription fees:

### ROI on Group 1

Adjusted population 375 customers; 75 customers receiving 10% subscription discounts; 300 customers receiving no discount
Adjusted customer loss cost=375*X−75*Y
Investment cost=375*Z

At block 110, selection recommendations are made based on criteria in the targeted groups. For example, subscribers with expiry <9 months, having Occupation “Engineer,” and without current subscription discounts will be offered an incentive. That is, at block 110, based on the optimization determined at block 142, an optimal set of the subgroups may be selected to receive a new inducement (e.g., another supplemental award), in an effort to encourage the members of the subgroups to continue the economic relationship. According to exemplary embodiments, groups of customers are analyzed to determine which groups are most cost-effective, rather than determining the distribution of discounts from an individual customer viewpoint (e.g., what, if anything, should be offered to this particular customer). In an exemplary embodiment, optimization is performed across different customer groups. That is, different inducements may be offered to different customer groups.

Exemplary embodiments of the present invention may provide a way to determine segments based on similar risk profiles, rather than assuming a given segment and providing a technique to evaluate the incentive scheme effectiveness based on customer lifetime value. Exemplary embodiments may provide a framework for identifying the target population. In evaluating impact, one or more embodiments may derive experimental and control groups within the population rather than focusing on causal factors.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

One or more embodiments of the invention, or elements thereof, may be implemented in the form of an apparatus including a memory and at least one processor that is coupled to the memory and operative to perform exemplary method steps.

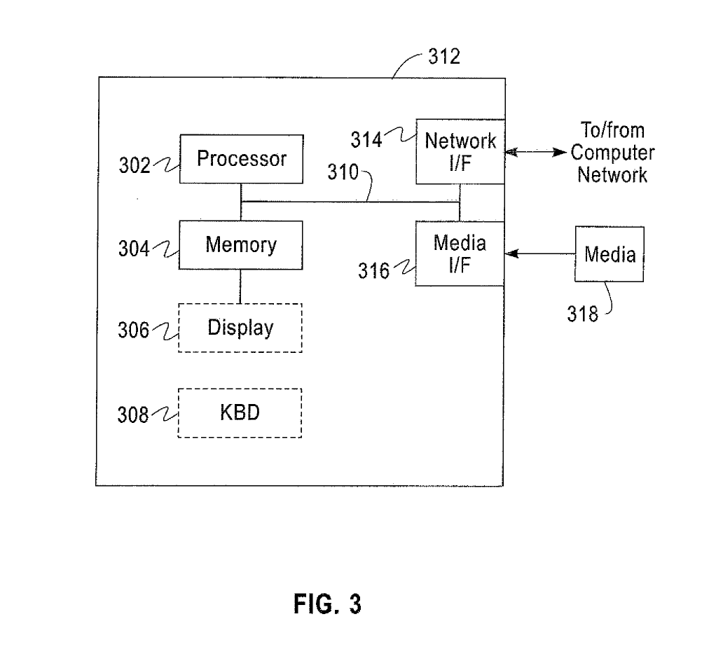

One or more embodiments can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a central processing unit (CPU) and/or other forms of processing circuitry. Further, the term “processor” may refer to more than one individual processor. The term “memory” is intended to include memory associated with a processor or CPU, such as, for example, random access memory (RAM), read only memory (ROM), a fixed memory device (e.g., a hard drive), a removable memory device (e.g., a diskette), a flash memory and the like. In addition, the phrase “input/output interface” as used herein is intended to include, for example, one or more mechanisms for inputting data to the processing unit (e.g., a mouse), and one or more mechanisms for providing results associated with the processing unit (e.g., a printer). The processor 302, memory 304, and input/output interface such as the display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in one or more of the associated memory devices (e.g., ROM, fixed or removable memory) and, when ready to be utilized, loaded in part or in whole (e.g., into RAM) and implemented by a CPU. Such software may include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (e.g., keyboards 308, displays 306, pointing devices, and the like) can be coupled to the system either directly (e.g., via bus 310) or through intervening I/O controllers.

Network adapters such as network interface 314 may also be coupled to the system to enable the data processing system to become coupled to other data processing systems or remote printers or storage devices through intervening private or public networks. Network adapters may include, for example, modems, Ethernet cards, and wireless adapters.

As used herein, a “server” includes a physical data processing system (e.g., system 312 as shown in FIG. 3) running a server program. It will be understood that such a physical server may or may not include a display and keyboard.

Aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, an electronic, magnetic, optical, electromagnetic, infrared, or semiconductor system, apparatus, or device, or any suitable combination of the foregoing, such as media block 318. More specific examples (a non-exhaustive list) of the computer readable storage medium include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. A computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (e.g., through the Internet using an Internet Service Provider).

Aspects of the present invention are described herein with reference to flowchart illustrations and/or block diagrams of methods, apparatuses (e.g., systems), and computer program products according to exemplary embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, or other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

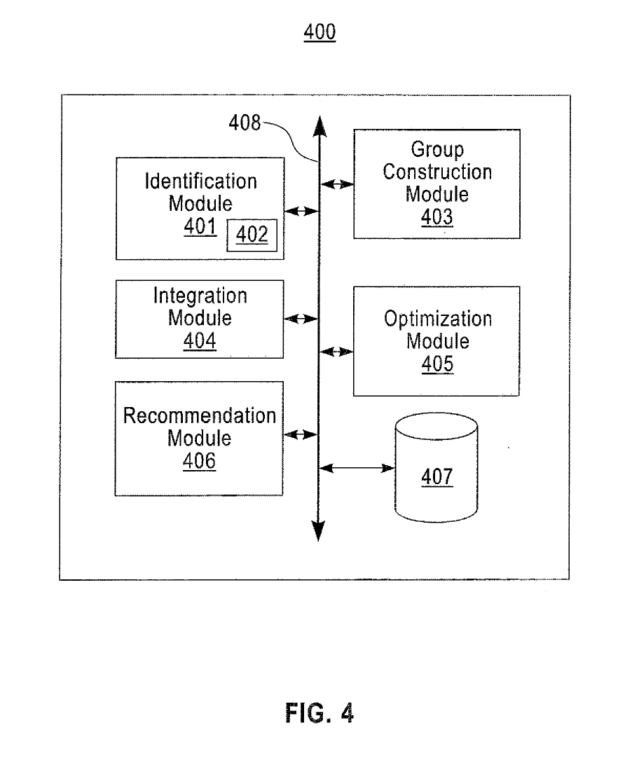

It should be noted that any of the methods described herein can include an additional step of providing a system comprising distinct software modules embodied on a computer readable storage medium. The modules can include, for example, any or all of the elements depicted in the block diagrams and/or described herein. For example, the modules may include an identification module, a group construction module, an integration module, and an optimization module, as well as other appropriate sub-modules, as described further with reference to FIG. 4. The method steps can then be carried out using the distinct software modules and/or sub-modules of the system, as described above, executing on one or more hardware processors 302. Further, a computer program product can include a computer-readable storage medium with code adapted to be implemented to carry out one or more method steps described herein, including the provision of the system with the distinct software modules.

FIG. 4 shows a system for performing optimal supplementary award allocation, according to an exemplary embodiment of the present invention.

Referring to FIGS. 1 and 4, the optimal supplementary award allocation system 400 includes an identification module 401, a group construction module 403, an integration module 404, an optimization module 405, and a recommendation module 406.

The identification of group features performed at block 102 may be implemented by an identification module 401, which may include a correlation analysis sub-module 402 performing the evaluation.

At block 102, data including variables potentially suitable for grouping the population may be obtained from a variety of sources including, for example, historical population behavior 112 from a historical population behavior database, a theory model 114 from a theory model database and/or domain expert information from a domain expert database. This data may be referred to as retention data.

The clustering performed at block 104 may be implemented by a group construction module 403. The group construction module 403 may receive the categorical factors 122 as an input, and may utilize, for example, decision trees, decision lists, k-means, or the like during clustering to identify the rules for defining the population. Dividing the subgroup into the experimental and control group may be performed by the group construction module 403 (e.g., using logic which examines a field in a database or the like to determine whether a previous inducement was received). The group construction module 403 may evaluate the effectiveness of previous inducements (e.g., block 132) based on a comparison of the experimental and control groups. For example, a comparison may be made based on retention rates (e.g., analyzing and comparing the average rate for both groups). In this case, if the retention rate of the group that received an award does not exceed the retention rate of the group that did not receive the award by a predetermined threshold, the award is not considered to have been effective. Based on the evaluation step (e.g., block 134), the group construction module 403 may generate a set of potential target groups, which may be output by the optimal supplementary award allocation system 400. For example, the population may be separated in a number of different manners until the manner resulting in the highest difference between recipients and non-recipients is obtained.

The filtering performed at block 106 (e.g., filtering potential target groups based on incentive program rules) may be implemented by an integration module 404, the optimization performed at block 108 may be implemented by an optimization module 405, and the selection recommendations performed at block 110 may be implemented by a recommendation module 406. The modules 401-406 may communicate with each other via a bus 408.

The components illustrated herein may be implemented in various forms of hardware, software, or combinations thereof. For example, application specific integrated circuit(s) (ASICS), functional circuitry, one or more appropriately programmed general purpose digital computers with associated memory, and the like may be utilized.

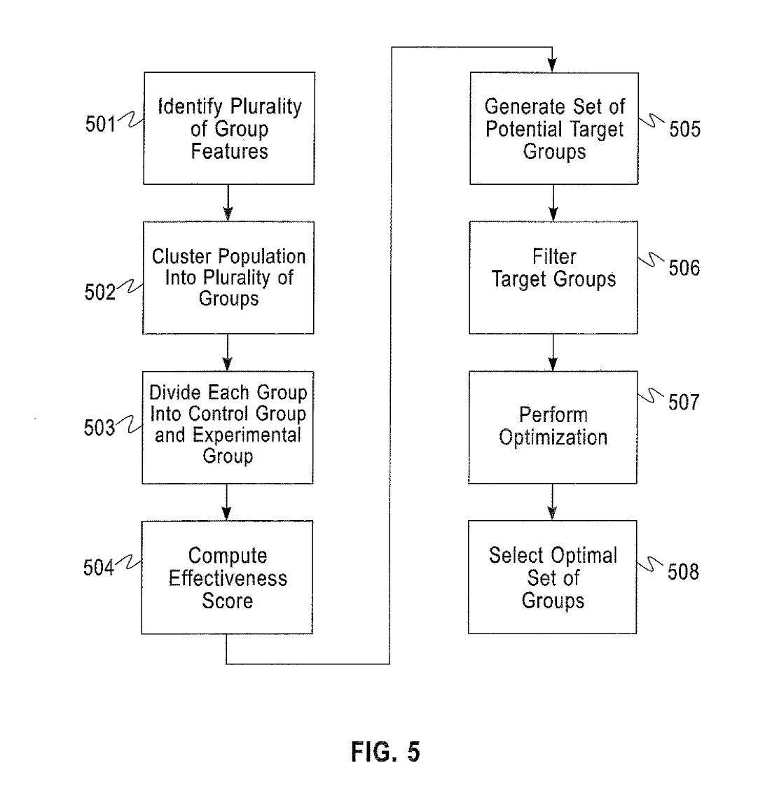

FIG. 5 is a flowchart showing a method of performing optimal supplementary award allocation, according to an exemplary embodiment of the present invention.

At block 501, a plurality of group features of a population are identified. The group features may be identified based on retention data. The retention data may be stored in a database 407 (e.g., a retention data database) that may be separate from and in communication with the optimal supplementary award allocation system 400, or may be included in the supplementary award allocation system 400.

At block 502, members of the population may be clustered into a plurality of groups having similar risk profiles, based on the plurality of group features, as well as a plurality of categorical factors. The plurality of groups may be stored in a database 407 (e.g., a group database) that may be separate from and in communication with the optimal supplementary award allocation system 400, or may be included in the supplementary award allocation system 400. The group database and the retention data database may be separate, or may be combined into a single database.

At block 503, each of the plurality of groups may be divided into an experimental group and a control group. As described above, the experimental groups correspond to members of the population that have received a previous incentive, and the control groups correspond to members of the population that have not received the previous incentive.

At block 504, an effectiveness score of the previous incentive is computed for each group based on a comparison of the each group's corresponding experimental group and control group. For example, for each group, a first retention rate corresponding to the group's experimental group may be computed, and a second retention rate corresponding to the group's control group may be computed. The effectiveness score for each group may then be computed based on a comparison of the first and second retention rates. The resulting difference can then be compared to a predefined threshold value. If the effectiveness score is greater than or equal to the threshold, a new incentive may be offered to that group. If the effectiveness score is below the threshold, the new incentive may not be offered to that group.

At block 505, a set of potential target groups for the new incentive may be generated based on the computed effectiveness scores.

At block 506, the generated potential target groups may be filtered based on program rule constraints, as described above.

At block 507, optimization may be performed. During optimization, the cost of offering the new incentive to each target group is compared to a benefit of retaining each target group. This difference is then compared to a predefined threshold to determine whether the new incentive should be offered to the group. At block 508, the optimal set of groups are selected.

Exemplary embodiments of the present invention may employ several components to provide a structured analysis on return-on-investment (ROI) through the iterative derivation and assessment of different customer sub-populations. The optimization objective is to maximize customer retention while minimizing costs (e.g., both the cost of award program investment and the cost of sales lost due to customer non-renewal).

Exemplary embodiments of the present invention may provide a methodological way to derive subpopulations with similar profiles and retention response characteristics, rather than relying on an ad hoc segmentation of the population,

Exemplary embodiments of the present invention may address optimal group-level behavior, rather than utilizing a per-customer response level based on personalized and/or targeted promotions. In addition, influences of the primary incentive scheme in the return on investment (ROI) analysis may be accounted for. Several components may be used to divide the population into experimental and control groups, so as to estimate the effectiveness of incentive award(s) on the subpopulation(s) and recommend the optimal supplementary award scheme.

Exemplary embodiments of the present invention may provide enhanced accuracy in determining what portion of a population to give a supplemental award to, for example, by integrating input from a variety of sources such as theoretical models, domain experts, and/or historical population behavior. Exemplary embodiments may further provide enhanced speed in iteratively picking and re-evaluating candidate groups in a visual manner by separating the groups into experimental and control groups.

Exemplary embodiments of the present invention may provide a system and method to determine population subgroup(s) to target supplementary incentive awards, so as to maximize return-on-investment (maximize subscriber retention and minimize costs). An exemplary embodiment may derive group features to segment a population into groups with similar retention behavior. An exemplary embodiment may cluster segmented populations by risk factors to obtain groups with similar risk profiles. In at least some cases, primary incentives may be used to construct the risk groups. Exemplary embodiments may assess the retention effectiveness by subdividing similar risk groups into experimental and control groups. An exemplary embodiment may generate a set of potential target groups based on retention effectiveness assessment. In at least some cases, subgroup selection is combined with award program constraints and/or the cost(s) and benefits of retention are optimized on subgroups with selection of the optimal set.

In exemplary embodiments, the supplementary award can vary continuously, or the supplementary award may be discrete or quantized. For example, the supplementary award may be a binary incentive (e.g., a determination of whether to allocate a gift certificate.

While the present invention has been particularly shown and described with reference to the exemplary embodiments thereof, it will be understood by those of ordinary skill in the art that various changes in form and detail may be made therein without departing from the spirit and scope of the present invention as defined by the following claims.

What is claimed is:

1. A method of allocating a new incentive to a portion of a population, comprising:
receiving retention data;
identifying a plurality of group features of the population based on the retention data;
clustering members of the population into a plurality of groups having similar risk profiles based on the plurality of group features and a plurality of categorical factors;
dividing each of the plurality of groups into an experimental group and a control group, wherein the experimental groups correspond to members of the population that have received a previous incentive, and the control groups correspond to members of the population that have not received the previous incentive;
computing an effectiveness score of the previous incentive for each group based on a comparison of a corresponding experimental group and a corresponding control group; and
generating a set of potential target groups for the new incentive based on the effectiveness scores.

2. The method of claim 1, further comprising:
filtering the set of potential target groups based on an incentive program rule.

3. The method of claim 2, wherein the incentive program rule indicates that the new incentive is not to be allocated to a target group having a subscription date that is more recent than a predefined subscription date.

4. The method of claim 2, wherein the incentive program rule indicates that the new incentive is not to be allocated to a target group having an age less than a predefined age.

5. The method of claim 1, further comprising selecting an optimal set of potential target groups from the generated set of potential target groups, wherein the optimal set is based on a cost-benefit analysis regarding retention of each of the generated potential target groups.

6. The method of claim 1, further comprising:
computing a first retention rate of the corresponding experimental group; and
computing a second retention rate of the corresponding control group,
wherein the effectiveness score is based on comparing a difference of the first and second retention rates to a predefined threshold value.

7. The method of claim 1, wherein the plurality of categorical factors comprise at least one of an occupation and an income bracket.

8. The method of claim 1, wherein at least some of said the plurality of categorical factors are obtained from a domain expert.

9. The method of claim 1, wherein at least some of the plurality of categorical factors are obtained from a theoretical model.

10. The method of claim 1, wherein at least some of the plurality of categorical factors are based on historical behavior.

11. The method of claim 1, wherein the previous incentive comprises a previous supplemental award, and the new incentive comprises a new supplemental award.

12. A method of allocating a new incentive to a portion of a population, comprising:
receiving retention data;
clustering members of the population into a plurality of groups based on the retention data;
dividing each of the plurality of groups into an experimental group and a control group, wherein the experimental groups correspond to members of the population that have received a previous incentive, and the control groups correspond to members of the population that have not received the previous incentive;
computing a first retention rate of each of the experimental groups;
computing a second retention rate of each of the control groups;
computing an effectiveness score of the previous incentive for each group based on the first retention rate, the second retention rate, and a predefined threshold; and
generating a set of potential target groups for the new incentive based on the effectiveness scores.

13. The method of claim 12, wherein the effectiveness score is computed by comparing a difference of the first and second retention rates to the predefined threshold.

14. The method of claim 12, further comprising:
filtering the set of potential target groups based on an incentive program rule.

15. The method of claim 14, wherein the incentive program rule indicates that the new incentive is not to be allocated to a target group having a subscription date that is more recent than a predefined subscription date.

16. The method of claim 14, wherein the incentive program rule indicates that the new incentive is not to be allocated to a target group having an age less than a predefined age.

17. The method of claim 12, further comprising selecting an optimal set of potential target groups from the generated set of potential target groups, wherein the optimal set is based on a cost-benefit analysis regarding retention of each of the generated potential target groups.

18. The method of claim 12, further comprising identifying a plurality of group features of the population based on the retention data, wherein clustering the members of the population into a plurality of groups is based on the plurality of group features and a plurality of categorical factors.

19. The method of claim 18, wherein the plurality of categorical factors comprise at least one of an occupation and an income bracket.

20. The method of claim 18, wherein at least some of said the plurality of categorical factors are obtained from a theoretical model.
